(19) United States
(12) Patent Application Publication
(10) Pub. No.: US 2005/0199585 A1
(43) Pub. Date: Sep. 15, 2005

(54) Method of depositing an amorphous carbon film for metal etch hardmask application

(75) Inventors: Yuxiang May Wang, Palo Alto, CA (US); David R. Bittrich, Madison, WI (US); Christopher Dennis Bencher, San Jose, CA (US); Heraldo L. Botelho, Palo Alto, CA (US); Sudha S. R. Rathi, San Jose, CA (US); Michael Chiu Kwan, Sunnyvale, CA (US)

Correspondence Address: MOSER, PATTERSON & SHERIDAN, LLP;APPLIED MATERIALS, INC., 3040 POST OAK BOULEVARD, SUITE 1500, HOUSTON, TX, 77056, US

(73) Assignee: Applied Materials, Inc.

(21) Appl. No.: 10/800,112

(22) Filed: Mar. 12, 2004

(51) Int. Cl. B44C 1/22; C23F 1/00; C23F 3/00

(52) U.S. Cl. 216/67; 216/41; 216/74

(57) ABSTRACT

Methods are provided for processing a substrate including etching conductive materials with amorphous carbon materials disposed thereon. In one aspect, the invention provides a method for processing a substrate including forming a conductive material layer on a surface of the substrate, depositing an amorphous carbon layer on the conductive material layer, etching the amorphous carbon layer to form a patterned amorphous carbon layer, and etching feature definitions in the conductive material layer corresponding to the patterned amorphous carbon layer. The amorphous carbon layer may act as a hardmask, an etch stop, or an anti-reflective coating.

### BACKGROUND OF THE DISCLOSURE

1. Field of the Invention

The invention relates to the fabrication of integrated circuits and to a process for depositing materials on a substrate and the structures formed by the materials.

2. Description of the Related Art

One of the primary steps in the fabrication of modern semiconductor devices is the formation of metal and dielectric layers on a substrate by chemical reaction of gases. Such deposition processes are referred to as chemical vapor deposition or CVD. Conventional thermal CVD processes supply reactive gases to the substrate surface where heat-induced chemical reactions take place to produce a desired layer.

Semiconductor device geometries have dramatically decreased in size since such devices were first introduced several decades ago. Since then, integrated circuits have generally followed the two year/half-size rule (often called Moore's Law), which means that the number of devices that will fit on a chip doubles every two years. Today's fabrication plants are routinely producing devices having 0.35 μm and even 0.18 μm feature sizes, and tomorrow's plants soon will be producing devices having even smaller geometries.

The demands for decreasing semiconductor device geometries also impose demands on the process sequences used for integrated circuit manufacture. For example, in process sequences using conventional lithographic techniques, a layer of energy sensitive resist is formed over a stack of material layers on a substrate. An image of a pattern is introduced into the energy sensitive resist layer. Thereafter, the pattern introduced into the energy sensitive resist layer is transferred into one or more layers of the material stack formed on the substrate using the layer of energy sensitive resist as a mask. The pattern introduced into the energy sensitive resist can be transferred into one or more layers of the material stack using a chemical etchant. The chemical etchant is designed to have a greater etch selectivity for the material layers of the stack than for the energy sensitive resist. That is, the chemical etchant etches the one or more layers of the material stack at a much faster rate than it etches the energy sensitive resist. The faster etch rate for the one or more material layers of the stack typically prevents the energy sensitive resist material from being consumed prior to completion of the pattern transfer.

As the pattern dimensions are reduced, the thickness of the energy sensitive resist must correspondingly be reduced in order to control pattern resolution. Such thinner resist layers (less than about 6000 Å) ban be insufficient to mask underlying material layers during a pattern transfer step using a chemical etchant. An intermediate oxide layer (e.g., silicon dioxide, silicon nitride), called a hardmask, is often used between the energy sensitive resist layer and the underlying material layers to facilitate pattern transfer into the underlying material layers. However, in some applications for forming semiconductor structures, removal of hardmask materials is difficult to accomplish and any remaining hardmask material may detrimentally affect semiconductor processing. Further, conventional hardmask materials may not provide sufficient etch selectivity between the material being etched and the hardmask to retain the desired dimensions of the features being formed.

Resist patterning problems are further compounded when lithographic imaging tools having deep ultraviolet (DUV) imaging wavelengths (e.g., less than about 250 nanometers (nm)) are used to generate the resist patterns. The DUV imaging wavelengths improve resist pattern resolution because diffraction effects are reduced at these shorter wavelengths. However, the increased reflective nature of many underlying materials, such as polysilicon, metals, and metal silicides at such DUV wavelengths, can degrade the resulting resist patterns.

One technique proposed to minimize reflections from an underlying material layer uses an anti-reflective coating (ARC). The ARC is formed over the reflective material layer prior to resist patterning. The ARC suppresses the reflections off the underlying material layer during resist imaging, providing accurate pattern replication in the layer of energy sensitive resist.

A number of ARC materials have been suggested for use in combination with energy sensitive resists. However, ARC materials, like hardmask materials are difficult to remove and may leave residues behind that potentially interfere with subsequent integrated circuit fabrication steps.

Therefore, a need exists in the art for a material layer useful for integrated circuit fabrication, which has good etch selectivity and/or anti-reflective properties that may further be removed with little or minimal residues.

### SUMMARY OF THE INVENTION

Aspects of the invention generally provide a method for etching conductive materials with amorphous carbon materials disposed thereon with minimal or reduced defect formation. In one aspect, the invention provides a method for processing a substrate including forming a conductive material layer on a surface of the substrate, depositing an amorphous carbon layer on the conductive material layer, etching the amorphous carbon layer to form a patterned amorphous carbon layer, and etching feature definitions in the conductive material layer corresponding to the patterned amorphous carbon layer.

In another aspect of the invention, a method is provided for processing a substrate including forming a conductive material layer on a surface of the substrate, depositing an amorphous carbon hardmask on the conductive material layer, depositing an anti-reflective coating on the amorphous carbon hardmask, depositing a patterned resist material on the anti-reflective coating, etching the anti-reflective coating and amorphous carbon hardmask to the conductive material layer, and etching feature definitions in the conductive material layer.

In another aspect of the invention, a method is provided for processing a substrate including forming an aluminum-containing layer on a surface of the substrate, depositing an amorphous carbon hardmask on the aluminum-containing layer, depositing an anti-reflective coating on the amorphous carbon hardmask, wherein the anti-reflective coating is a material selected from the group of silicon nitride, silicon carbide, carbon-doped silicon oxide, amorphous carbon, and combinations thereof, depositing a patterned resist material on the anti-reflective coating, etching the anti-reflective coating and amorphous carbon hardmask to the aluminum-containing layer, removing the resist material, etching feature definitions in the aluminum-containing layer at an etch selectivity of amorphous carbon to the aluminum-containing between about 1:3 and about 1:10, and removing the one or more amorphous carbon layers by exposing the one or more amorphous carbon layers to a plasma of a hydrogen-containing gas or an oxygen-containing gas.

### BRIEF DESCRIPTION OF THE DRAWINGS

So that the manner in which the above features of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A-1E are cross sectional views showing one embodiment of a dual damascene deposition sequence of the invention;

For a further understanding of aspect of the invention, reference should be made to the ensuing detailed description.

### DETAILED DESCRIPTION OF THE PREFERRED EMBODIMENTS

Aspects of the invention generally provide methods for depositing, processing and removing amorphous carbon material disposed on a conductive material with minimal or reduced defect formation. The words and phrases used herein should be given their ordinary and customary meaning in the art by one skilled in the art unless otherwise further defined.

The following deposition processes are described with use of the 300 mm Producer™ dual deposition station processing chamber, and should be interpreted accordingly, for example, flow rates are total flow rates and should be divided in two to describe the process flow rates at each deposition station in the chamber. Additionally, for single deposition chambers, such as the DxZ processing chamber, commercially available from Applied Materials, Inc., of Santa Clara, Calif., may perform the following process with appropriate process conversions, i.e., adjusting flow rated from total dual deposition station Producer™ processing chamber flow rates to single deposition station flow rates.

The amorphous carbon material is deposited on a conductive material. The amorphous carbon material may then be patterned and etched to form feature definitions therein. The underlying conductive material is then etched, and the amorphous carbon material is then removed from the substrate surface. The conductive material may include, for example, aluminum or an aluminum alloy.

An amorphous carbon layer is then deposited on the conductive material by a process including introducing a gas mixture of one or more hydrocarbon compounds into a processing chamber. The hydrocarbon compound has a formula CₓH_{y}, where x has a range of between 2 and 4 and y has a range of between 2 and 10. For example, propylene (C₃H₆), propyne (C₃H₄), propane (C₃H₈), butane (C₄H₁₀), butylene (C₄H₈), butadiene (C₄H₆), or acetylene (C₂H₂) as well as combinations thereof, may be used as the hydrocarbon compound.

Alternatively, partially or completely fluorinated derivatives of the hydrocarbon compounds may be used. The fluorinated hydrocarbons compounds have a formula CₓH_{y}F_{z}, where x has a range of between 2 and 4, y has a range of between 0 and 10, z has a range of between 0 and 10, with y+z greater than or equal to 2 and less than or equal to 10. Examples include fully fluorinated hydrocarbons, such as C₃F₈ or C₄F₈, which may be used to deposit a fluorinated amorphous carbon layer, which may be described as an amorphous fluorocarbon layer. A combination of hydrocarbon compounds and fluorinated derivatives of hydrocarbon compounds may be used to deposit the amorphous carbon layer or amorphous fluorocarbon layer. Alternatively, hydrocarbon compounds, and fluorinated derivatives thereof, including alkanes, alkenes, alkynes, cyclic compounds, and aromatic compounds, having five or more carbons, such as pentane, benzene, and toluene, may be used to deposit amorphous carbon layers.

Inert and reactive gases may be added to the gas mixture to modify properties of the amorphous carbon material. The gases may be reactive gases, such as hydrogen (H₂), ammonia (NH₃), a mixture of hydrogen (H₂) and nitrogen (N₂), or combinations thereof. The addition of H₂ and/or NH₃ can be used to control the hydrogen ratio of the amorphous carbon layer to control layer properties, such as reflectivity. Inert gases, such as nitrogen (N₂), and noble gases, including Argon (Ar) and Helium (He), may be used to control the density and deposition rate of the amorphous carbon layer. A mixture of reactive gases and inert gases may be added to the processing gas to deposit an amorphous carbon layer.

The amorphous carbon layer may be deposited from the processing gas by maintaining a substrate temperature between about 100° C. and about 400° C., such as between about 250° C. and about 400° C., maintaining a chamber pressure between about 1 Torr and about 20 Torr, introducing the hydrocarbon gas (CₓH_{y}), and any inert or reactive gases respectively, at a flow rate between about 50 sccm and about 2000 sccm for a 200 mm substrate, a plasma is generated by applying a RF power of between about 0.03 W/cm² and about 20 W/cm², or between about 10 watts (W) and about 6000 W, for example between about 0.3 W/cm² and about 3 W/cm², or between about 100 W and about 1000 W for a 200 mm substrate, with a gas distributor being between about 200 mils and about 600 mils from the substrate surface. The above process parameters provide a typical deposition rate for the amorphous carbon layer in the range of about 100 Å/min to about 5000 Å/min. The process can be implemented on a 200 mm substrate in a deposition chamber, such as the Producer™ processing chamber, commercially available from Applied Materials, Inc., of Santa Clara Calif. Other suitable deposition apparatus, such as the DxZ™ processing chamber commercially available from Applied Materials, Inc., of Santa Clara Calif., may be used.

Alternatively, a dual-frequency system may be applied to deposit the amorphous carbon material. A dual-frequency source of mixed RF power provides a high frequency power in a range between about 10 MHz and about 30 MHz, for example, about 13.56 MHz, as well as a low frequency power in a range of between about 100 KHz and about 500 KHz, for example, about 350 KHz. An example of a mixed frequency RF power application may include a first RF power with a frequency in a range of about 10 MHz and about 30 MHz at a power in a range of about 200 watts to about 800 watts and at least a second RF power with a frequency in a range of between about 100 KHz and about 500 KHz as well as a power in a range of about 1 watt to about 200 watts. The ratio of the second RF power to the total mixed frequency power is preferably less than about 0.6 to 1.0.

The high frequency RF power and the low frequency RF power may be coupled to a gas distributor (showerhead) or a substrate support, or one may be, coupled to the showerhead and the other to the support pedestal. Details of the mixed RF power source 119 are described in commonly assigned U.S. Pat. No. 6,041,734, entitled, “Use of an Asymmetric Waveform to Control Ion Bombardment During Substrate Processing”, issued on Mar. 28, 2000, and is herein incorporated by reference.

The amorphous carbon layer comprises carbon and hydrogen atoms, which may be an adjustable carbon:hydrogen ratio that ranges from about 10% hydrogen to about 60% hydrogen. Controlling the hydrogen ratio of the amorphous carbon layer is desirable for tuning the respective optical properties, etch selectivity and chemical mechanical polishing resistance properties. Specifically, as the hydrogen content decreases the optical properties of the as-deposited layer such as for example, the index of refraction (n) and the absorption coefficient (k) increase. Similarly, as the hydrogen content decreases the etch resistance of the amorphous carbon layer increases.

The light absorption coefficient, k, of the amorphous carbon layer can be varied between about 0.1 to about 1.0 at wavelengths below about 250 nm, such as between about 193 nm and about 250 nm, making the amorphous carbon layer suitable for use as an anti-reflective coating (ARC) at DUV wavelengths as well as visible wavelengths. The absorption coefficient of the amorphous carbon layer can be varied as a function of the deposition temperature. In particular, as the temperature increases the absorption coefficient of the as-deposited layer likewise increases. For example, when propylene is the hydrocarbon compound the k value for the as-deposited amorphous carbon layers can be increased from about 0.2 to about 0.7 by increasing the deposition temperature from about 150° C. to about 480° C.

The absorption coefficient of the amorphous carbon layer can also be varied as a function of the additive used in the gas mixture. In particular, the presence of hydrogen (H₂), ammonia (NH₃), and nitrogen (N₂), or combinations thereof, in the gas mixture can increase the k value by about 10% to about 100%. The amorphous carbon layer is further described in U.S. Pat. No. 6,573,030, issued on Jun. 3, 2003, entitled, “Method for Depositing an Amorphous Carbon Layer”, which is incorporated herein to the extent not inconsistent with the claimed aspects and description herein.

In an alternate embodiment, the amorphous carbon layer can have an absorption coefficient (k) that varies across the thickness of the layer. That is, the amorphous carbon layer can have an absorption coefficient gradient formed therein. Such a gradient is formed as a function of the variations of temperature and the composition of the gas mixture during layer formation.

At any interface between two material layers, reflections can occur because of differences in their refractive indices (n) and absorption coefficients (k). When the amorphous carbon ARC has a gradient, it is possible to match the refractive indices (n) and the absorption coefficients (k) of the two material layers so there is minimal reflection and maximum transmission into the amorphous carbon ARC. Then the refractive index (n) and absorption coefficient (k) of the amorphous carbon ARC can be gradually adjusted to absorb all of the light transmitted therein.

The amorphous carbon layer may be deposited with two or more layers having different optical properties. For example, an amorphous carbon bi-layer may include a first amorphous carbon layer according to the process parameters described above and is designed primarily for light absorption. As such, the first amorphous carbon layer 230 has an index of refraction in the range of about 1.5 to about 1.9 and an absorption coefficient (k) in the range of about 0.5 to about 1.0 at wavelengths less than about 250 nm. A second amorphous carbon layer, for example, an anti-reflective coating layer, may be formed on the first amorphous carbon layer according to the process parameters described above to have an index of refraction between about 1.5 and about 1.9, and an absorption coefficient between about 0.1 and about 0.5. The second amorphous carbon layer is designed primarily for phase shift cancellation by creating reflections that cancel those generated at the interface with an overlying material layer, such as an energy sensitive resist material, for example, a resist. The refractive index (n) and the absorption coefficient (k) of the first and second amorphous carbon layers are tunable, in that they can be varied as a function of the temperature as well as the composition of the gas mixture during layer formation.

Removal of the amorphous carbon material from the dielectric material may be achieved by subjecting the amorphous carbon layer to a plasma of a hydrogen-containing gas and/or an oxygen-containing gas. The plasma of the hydrogen-containing gas and/or the oxygen-containing gas is believed to remove the amorphous carbon material with minimal effect of the dielectric material disposed thereunder.

The plasma treatment generally includes providing the hydrogen containing gas including hydrogen, ammonia, water vapor (H₂O), or combinations thereof, to a processing chamber at a flow rate between about 100 sccm and about 1000 sccm, preferably between about 500 sccm and about 1000 sccm, and generating a plasma in the processing chamber. The plasma may be generated using a power density ranging between about 0.15 W/cm² and about 5 W/cm², which is a RF power level of between about 50 W and about 1500 W for a 200 mm substrate. The RF power can be provided at a high frequency such as between 13 MHz and 14 MHz. The RF power can be provided continuously or in short duration cycles wherein the power is on at the stated levels for cycles less than about 200 Hz and the on cycles total between about 10% and about 30% of the total duty cycle.

The plasma treatment may be performed by maintaining a chamber pressure of between about 1 Torr and about 10 Torr, preferably between about 3 Torr and about 8 Torr, maintaining the substrate at a temperature between about 100° C. and about 300° C. during the plasma treatment, preferably, between about 200° C. and about 300° C., for between about 15 seconds and about 120 seconds, or as necessary to remove the amorphous carbon material with the gas distributor positioned between about 100 mils and about 2000 mils from the substrate surface, preferably positioned between about 200 mils and about 1000 mils, during the plasma treatment. However, it should be noted that the respective parameters may be modified to perform the plasma processes in various chambers and for different substrate sizes, such as between 200 mm and 300 mm substrates. Alternatively, the plasma treatment process parameters may be the same or substantially the same as the material deposition process parameters.

A suitable reactor for performing the amorphous carbon material deposition and the hydrogen-containing gas plasma removal of the amorphous carbon materials described herein may be performed in a Producer™ processing chamber or a DxZ™ chemical vapor deposition chamber commercially available from Applied Materials, Inc., Santa Clara, Calif.

Conductive Feature Formation

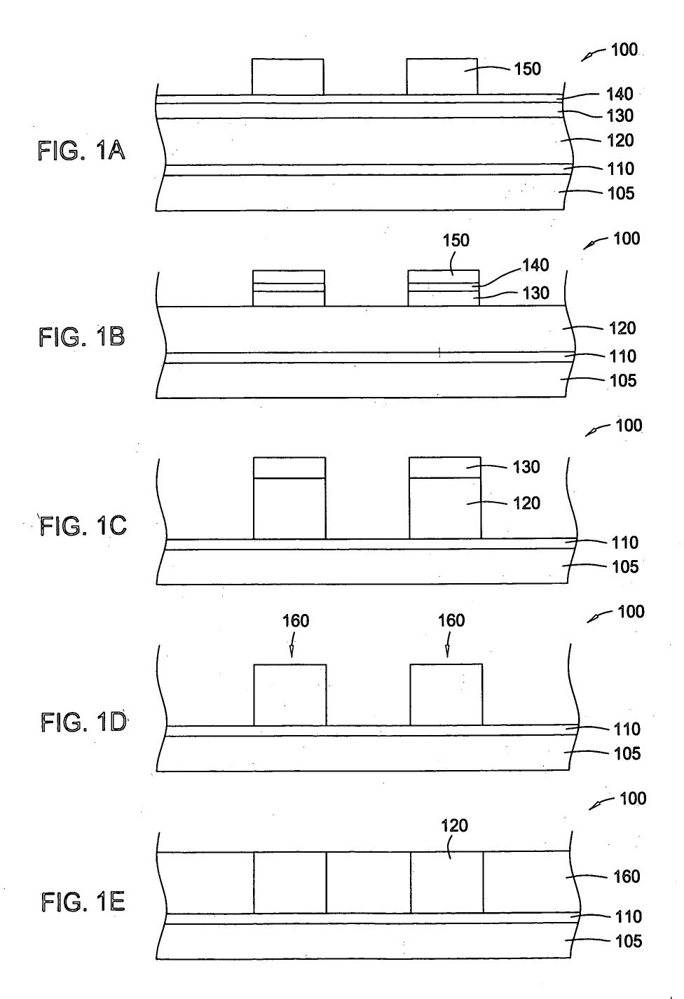

An example of a conductive feature formed with amorphous carbon as an hardmask and/or anti-reflective coating (ARC) and the amorphous carbon material removal process described herein is shown in FIGS. 1A-E, which are cross sectional views of a substrate having the steps of the invention formed thereon.

As shown in FIG. 1A, an optional barrier layer 110 is deposited on the substrate surface to eliminate inter-level diffusion between the substrate 100 and subsequently deposited material. The substrate surface 105 may comprise a dielectric or conductive material, and while not shown, the substrate surface 105 may comprise metal features formed in a dielectric material. The barrier layer 110 may be deposited to a thickness of about 100 Å to about 1000 Å.

The barrier layer 110 may comprise any conventional barrier layer material including, for example, silicon nitride, silicon oxynitride, or combinations thereof. The barrier layer may also include a low dielectric constant material, such as silicon carbide or nitrogen containing silicon carbide having a dielectric constant of about 5 or less. An example of a low k material BLOk™ dielectric material commercially available from Applied Materials, Inc., of Santa Clara, Calif.

A conductive material layer 120 is deposited on the barrier layer 110. The conductive material may be a metal, for example aluminum or aluminum alloy. The conductive material layer 120 may comprise other conductive materials including polysilicon, tungsten, and metal silicides, such as tungsten silicide. The list of materials is illustrative and is not to be construed or interpreted as limiting the scope of the invention.

The conductive material layer 120 maybe deposited on the barrier layer 110 by, for example, chemical vapor deposition, including atomic layer deposition techniques, physical vapor deposition, including high density physical vapor deposition techniques, electrochemical deposition, including electroplating and electroless deposition techniques, or a combination of deposition techniques. The conductive material layer 120 may also be deposited to a thickness between about 2,000 Å and about 4,000 Å, and may vary in thickness depending on the size of the structure to be fabricated.

An amorphous carbon layer 130 is then deposited on the conductive material layer 120. Typically, the amorphous carbon layer has a thickness in the range of about 50 Å to about 1000 Å. The amorphous carbon layer 130 is a hardmask which may perform as a stop for chemical mechanical polishing techniques to allow selective removal of materials while protecting underlying materials, such as the conductive material layer 120, from damage during etching or from polishing methods.

The amorphous carbon layer 130 may also perform as a hardmask or etch stop and allow for selective removal of the underlying conductive material. The hardmask provides a selectivity, or removal rate ratio, of amorphous carbon to conductive material of about 1:3 or greater, preferably between greater than about 1:3 to about 1:10. The reduced rate of removal of the amorphous carbon layer 130 allows for effective conductive material etch without loss of the amorphous carbon layer which defines the definitions of the features being etched into the conductive material. The hardness of the amorphous carbon layer has also been observed to increase, which enhances selectivity to oxide allows for a better corner integrity during etching of the subsequent metal material, such as aluminum.

The amorphous carbon layer may also perform as an anti-reflective coating. Specifically, as the hydrogen content decreases the optical properties of the amorphous carbon layer such as the index of refraction (n) and the absorption coefficient (k) increase. Similarly, as the hydrogen content decreases the etch resistance of the amorphous carbon layer increases. The light absorption coefficient, k, of the amorphous carbon layer can be varied between about 0.1 to about 1.0 at wavelengths below about 250 nm, such as between about 193 nm and about 250 nm, making the amorphous carbon layer suitable for use as an anti-reflective coating (ARC) at DUV wavelengths. Typically, the amorphous carbon layer 130 has a thickness of about 200 Å to about 1100 Å. Further multiple layers of amorphous carbon may be used for the anti-reflective coating. For example, the amorphous carbon bilayer ARC layer described herein may be used as the anti-amorphous carbon layer 130.

Dependant on the etch chemistry of the energy sensitive resist material used in the fabrication sequence, an optional capping layer (not shown) is formed on the amorphous carbon layer 130. The optional capping layer functions as a mask for the amorphous carbon layer 130 when the pattern is transferred therein. The optional capping layer may comprise a material including an oxide, such as silicon oxide, a nitride, such as silicon nitride or titanium nitride, silicon oxynitride, silicon carbide, amorphous silicon, undoped silica glass (USG), doped silicon oxide, or other materials. The optional capping layer may be deposited to a thickness between about 300 Å and about 1000 Å, but layer thickness may vary on process requirements. The cap layer is believed to protect the amorphous carbon layer from the photoresist as well as cover any layer imperfections, such as pinholes formed in the amorphous carbon material.

Optionally, an anti-reflective coating 140 may be deposited on the amorphous carbon layer 130. The anti-reflective coating may comprise a material selected from the group consisting of an oxide, nitride, silicon oxynitride, silicon carbide, amorphous silicon, and combinations thereof. The anti-reflective coating 140 may function as a hardmask for the amorphous carbon layer 130 when the pattern is transferred therein. The dual layer structure of the amorphous carbon layer and the anti-reflective coating is believed to allow much thinner subsequent photoresist usage, which would then allow a smaller critical dimensions resolution.

Alternatively, the anti-reflective coating 140 may comprise another amorphous carbon layer. If the anti-reflective coating 140 is an amorphous carbon layer, the amorphous carbon bi-layer may include a first amorphous carbon layer 130 according to the process parameters described above and is designed primarily for light absorption. As such, the first amorphous carbon layer 130 has an index of refraction in the range of about 1.5 to about 1.9 and an absorption coefficient (k) in the range of about 0.5 to about 1.0 at wavelengths less than about 250 nm. The thickness of the first amorphous carbon layer 130 is variable depending on the specific stage of processing. Typically, the first amorphous carbon layer 130 has a thickness in the range of about 300 Å to about 1500 Å.

A second amorphous carbon layer, the anti-reflective coating layer 140, is formed on the first amorphous carbon layer 130 according to the process parameters described above to have an index of refraction between about 1.5 and about 1.9, and an absorption coefficient between about 0.1 and about 0.5. The second amorphous carbon layer 140 is designed primarily for phase shift cancellation by creating reflections that cancel those generated at the interface with an overlying material layer, such as an energy sensitive resist material, for example, a resist. The thickness of the second amorphous carbon layer 140 is also variable depending on the specific stage of processing, for example, between about 300 Å and about 700 Å. The refractive index (n) and the absorption coefficient (k) of the first and second amorphous carbon layers are tunable, in that they can be varied as a function of the temperature as well as the composition of the gas mixture during layer formation.

An energy resist material, such as a resist 150, is deposited and patterned on the surface of the amorphous carbon material. The resist layer 150 can be spin coated on the substrate to a thickness within the range of about 200 Å to about 6000 Å. Photoresist materials are sensitive to ultraviolet (UV) radiation having a wavelength less than about 450 nm. DUV resist materials are sensitive to UV radiation having wavelengths of 245 nm or 193 nm. An image of a pattern is introduced into the layer of resist material 150 by exposure to UV radiation via a photolithographic reticle. The image of the pattern introduced in the layer of resist material 150 is developed in an appropriate developer to define the pattern as shown in FIG. 1A.

The pattern defined in the resist material 150 is transferred through the amorphous carbon layer 130 and any intervening layer, such as anti-reflective coating 140 as shown in FIG. 1B. The pattern is transferred through the amorphous carbon layer 130 and any intervening layer by etching using an appropriate chemical etchant. For Example, ozone, oxygen or ammonia plasmas may be used to etch amorphous carbon materials. Multiple etching step including variable etching gas composition may be use to etch through the amorphous carbon layer 130 and any intervening layer. Optionally, any remaining resist material after the etching process may be removed prior to further processing.

The pattern formed in the amorphous carbon layer 130 may then be transferred to the conductive material layer 120 and any intervening layer by etching using an appropriate chemical etchant to form conductive material features 160 as shown in FIG. 1D. Any known conductive material etchant may be used to etch the conductive material 120.

The amorphous carbon layer 130 is then exposed to a plasma of a hydrogen-containing gas to remove the amorphous containing material from the surface of the substrate. An example of the hydrogen-containing plasma removal process may be performed by introducing hydrogen gas at a flow rate of about 1000 sccm, maintaining a chamber pressure of about 5 Torr, maintaining a substrate temperature at about 250° C., generating a plasma by supplying a RF power level of between about 100 W and about 300 W for a 200 mm substrate, and maintaining the plasma for about 60 seconds, or as necessary to remove the amorphous carbon material. The gas distributor is positioned about 500 mils from the substrate surface during the plasma treatment as shown in FIG. 1D. Any remaining intervening materials, such as the ARC material, are removed by the conductive material etchant or by the amorphous carbon removal process. The invention contemplates that a separate removal process for the ARC layer may be necessary to remove such layer residues prior to amorphous carbon removal.

Dielectric materials including low k dielectric material may be deposited and planarized to electrically isolate features 160 from each other as shown in FIG. 1E. An example of a gap-fill process with low k dielectric material is disclosed in U.S. Pat. No. 6,054,379, issued Apr. 25, 2000, which is incorporated herein by reference to the extent not inconsistent with the disclosure and claimed aspects herein.

### EXAMPLES

The following examples demonstrate various embodiments of the adhesion processes described herein as compared to a standard interlayer stack to illustrate the improved interlayer adhesion. The samples were undertaken using a chemical vapor deposition chamber, and in dual processing station Producer™ 200 mm and 300 mm processing chambers, which includes a solid-state dual frequency RF matching unit with a two-piece quartz process kit, both fabricated and sold by Applied Materials, Inc., Santa Clara, Calif.

Amorphous carbon films were deposited as follows. An amorphous carbon layer was deposited with a single frequency and helium carrier gas by introducing propylene, C₃H₆, at a flow rate of about 1200 sccm and helium at a flow rate of about 650 sccm, optionally maintaining the chamber at a substrate temperature of about 400° C., maintaining a chamber pressure of about 7 Torr, positioning a gas distributor at about 240 mils from the substrate surface, and applying a RF power of about 900 watts at about 13.56 MHz. The deposited process was observed to have a deposition rate of about 3290 A/min, an n value of about 1.64, and an optical k value of about 0.343.

An amorphous carbon layer was deposited with a single frequency and argon carrier gas by introducing propylene, C₃H₆, at a flow rate of about 1200 sccm and argon at a flow rate of about 1200 sccm, optionally maintaining the chamber at a substrate temperature of about 400° C., maintaining a chamber pressure of about 7 Torr, positioning a gas distributor at about 240 mils from the substrate surface, and applying a RF power of about 700 watts at about 13.56 MHz. The deposited process was observed to have a deposition rate of about 4900 A/min, an n value of about 1.619, and an optical k value of about 0.363.

An amorphous carbon layer was deposited with a single frequency and helium carrier gas by introducing propylene, C₃H₆, at a flow rate of about 1000 sccm and helium at a flow rate of about 650 sccm, optionally maintaining the chamber at a substrate temperature of about 400° C., maintaining a chamber pressure of about 7 Torr, positioning a gas distributor at about 240 mils from the substrate surface, and applying a RF power of about 700 watts at about 13.56 MHz. The deposited process was observed to have a deposition rate of about 1874 A/min, an n value of about 1.648, and an optical k value of about 0.342.

An amorphous carbon layer was deposited with a single frequency and argon carrier gas by introducing propylene, C₃H₆, at a flow rate of about 1000 sccm and argon at a flow rate of about 1200 sccm, optionally maintaining the chamber at a substrate temperature of about 400° C., maintaining a chamber pressure of about 7 Torr, positioning a gas distributor at about 240 mils from the substrate surface, and applying a RF power of about 700 watts at about 13.56 MHz. The deposited process was observed to have a deposition rate of about 3320 A/min, an n value of about 1.631, and an optical k value of about 0.348.

An amorphous carbon layer was deposited with a dual frequency and argon carrier gas by introducing propylene, C₃H₆, at a flow rate of about 1000 sccm and argon at a flow rate of about 1200 sccm, optionally maintaining the chamber at a substrate temperature of about 400° C., maintaining a chamber pressure of about 7 Torr, positioning a gas distributor at about 240 mils from the substrate surface, and applying a RF power of about 700 watts at about 13.56 MHz and about 100 watts at 350 KHz. The deposited process was observed to have a deposition rate of about 4032 A/min, an n value of about 1.618, and an optical k value of about 0.365. It is believed that dual-frequency depositions provide improved selectivity.

A high deposition rate amorphous carbon layer was deposited with a single frequency and argon and helium carrier gas by introducing propylene, C₃H₆, at a flow rate of about 650 sccm, argon at a flow rate of about 1450 sccm, and helium at a flow rate of about 500 sccm, optionally maintaining the chamber at a substrate temperature of about 400° C., maintaining a chamber pressure of about 10 Torr, positioning a gas distributor at about 210 mils from the substrate surface, and applying a RF power of about 715 watts at about 13.56 MHz. The deposited process was observed to have a deposition rate of about 4,000 A/min.

While the foregoing is directed to preferred embodiments of the present invention, other and further embodiments of the invention may be devised without departing from the basic scope thereof, and the scope thereof is determined by the claims that follow.

1. A method for processing a substrate in a processing chamber, comprising:
forming a conductive material layer on a surface of the substrate;
depositing an amorphous carbon layer on the conductive material layer;
etching the amorphous carbon layer to form a patterned amorphous carbon layer; and
etching feature definitions in the conductive material layer corresponding to the patterned amorphous carbon layer.

2. The method of claim 1, wherein the conductive material is selected from the group of aluminum or aluminum alloy.

3. The method of claim 1, wherein the depositing an amorphous carbon layer comprises:
introducing into the processing chamber one or more hydrocarbon compounds having the general formula CₓH_{y}, wherein x has a range of 2 to 4 and y has a range of 2 to 10; and
generating a plasma of the one or more hydrocarbon compounds.

4. The method of claim 3, wherein the one or more hydrocarbon compounds are selected from the group consisting of propylene (C₃H₆), propyne (C₃H₄), propane (C₃H₈), butane (C₄H₁₀), butylene (C₄H₈), butadiene (C₄H₆), acetelyne (C₂H₂), and combinations thereof.

5. The method of claim 3, further comprising introducing an inert gas with the one or more hydrocarbons into the processing chamber.

6. The method of claim 3, wherein the generating a plasma comprises applying power from a dual-frequency RF source.

7. The method of claim 1, wherein the etch selectivity of amorphous carbon to the conductive material is between about 1:3 and about 1:10.

8. The method of claim 1, wherein the amorphous carbon layer comprises an anti-reflective coating.

9. A method for processing a substrate in a chamber, comprising:
forming a conductive material layer on a surface of the substrate;
depositing an amorphous carbon hardmask on the conductive material layer;
depositing an anti-reflective coating on the amorphous carbon hardmask;
depositing a patterned resist material on the anti-reflective coating;
etching the anti-reflective coating and amorphous carbon hardmask to the conductive material layer; and
etching feature definitions in the conductive material layer.

10. The method of claim 9, wherein the conductive material is selected from the group of aluminum or aluminum alloy.

11. The method of claim 9, wherein the depositing an amorphous carbon hardmask comprises:
introducing into the processing chamber one or more hydrocarbon compounds having the general formula CₓH_{y}, wherein x has a range of 2 to 4 and y has a range of 2 to 10; and
generating a plasma of the one or more hydrocarbon compounds.

12. The method of claim 11, wherein the one or more hydrocarbon compounds are selected from the group consisting of propylene (C₃H₆), propyne (C₃H₄), propane (C₃H₈), butane (C₄H₁₀), butylene (C₄H₈), butadiene (C₄H₆), acetelyne (C₂H₂), and combinations thereof.

13. The method of claim 11, further comprising introducing an inert gas with the one or more hydrocarbons into the processing chamber.

14. The method of claim 11, wherein the generating a plasma comprises applying power from a dual-frequency RF source.

15. The method of claim 9, wherein the anti-reflective coating is a material selected from the group of silicon nitride, silicon carbide, carbon-doped silicon oxide, amorphous carbon, and combinations thereof.

16. The method of claim 9, further comprising depositing a barrier layer prior to depositing the aluminum layer.

17. The method of claim 9, further comprising removing the resist material prior to etching feature definitions in the aluminum layer.

18. The method of claim 9, wherein the etch selectivity of amorphous carbon to the conductive material is between about 1:3 and about 1:10.

19. A method for processing a substrate in a chamber, comprising:
forming an aluminum-containing layer on a surface of the substrate;
depositing an amorphous carbon hardmask on the aluminum-containing layer;
depositing an anti-reflective coating on the amorphous carbon hardmask, wherein the anti-reflective coating is a material selected from the group of silicon nitride, silicon carbide, carbon-doped silicon oxide, amorphous carbon, and combinations thereof;
depositing a patterned resist material on the anti-reflective coating;
etching the anti-reflective coating and amorphous carbon hardmask to the aluminum-containing layer;
removing the resist material;
etching feature definitions in the aluminum-containing layer at an etch selectivity of amorphous carbon to the aluminum-containing between about 1:3 and about 1:10; and
removing the one or more amorphous carbon layers by exposing the one or more amorphous carbon layers to a plasma of a hydrogen-containing gas or an oxygen-containing gas.

20. The method of claim 19, wherein the one or more hydrocarbon compounds are selected from the group consisting of propylene (C₃H₆), propyne (C₃H₄), propane (C₃H₈), butane (C₄H₁₀), butylene (C₄H₈), butadiene (C₄H₆), acetelyne (C₂H₂), and combinations thereof.

21. The method of claim 19, further comprising introducing an inert gas with the one or more hydrocarbons into the processing chamber.

22. The method of claim 19, wherein the generating a plasma comprises applying power from a dual-frequency RF source.
